(19) United States
(12) Patent Application Publication
(10) Pub. No.: US 2002/0182525 A1
(43) Pub. Date: Dec. 5, 2002

(54) Black toner

(76) Inventors: Kazuyuki Hayashi, Hiroshima-shi (JP); Hiroko Morii, Hiroshima-shi (JP); Yasuyuki Tanaka, Onoda-shi (JP); Seiji Ishitan, Hiroshima-shi (JP)

Correspondence Address: NIXON & VANDERHYE P.C., 8th Floor, 1100 North Glebe Road, Arlington, VA, 22201, US

(21) Appl. No.: 10/073,362

(22) Filed: Feb. 13, 2002

Related U.S. Application Data
(63) Continuation-in-part of application No. 09/635,424, filed on Aug. 10, 2000.
Application No. 09/635,424 is a continuation-in-part of application No. 09/553,546, filed on Apr. 20, 2000.
Application No. 09/553,546 is a continuation-in-part of application No. 09/276,519, filed on Mar. 25, 1999, now abandoned.

(30) Foreign Application Priority Data
Mar. 26, 1998 (JP) 10-100136
Aug. 11, 1999 (JP) 11-227826
Apr. 28, 2000 (JP) 2000-131864
Mar. 25, 1999 (EP) 99302317.5
Aug. 10, 2000 (EP) 00306818.6

(51) Int. Cl. G03G 9/09

(52) U.S. Cl. 430/108.3; 430/108.6; 430/108.9

(57) ABSTRACT

A black toner comprising:

a binder resin; and

black non-magnetic composite particles having an average particle diameter of 0.06 to 1.0 μm, comprising:

hematite particles or iron oxide hydroxide particles as core particles;

a single coating layer formed on the surface of said hematite particles or iron oxide hydroxide particles, comprising at least one organosilicon compound selected from the group consisting of:

(1) organosilane compounds obtained from an alkoxysilane compounds, and

(2) polysiloxanes or modified polysiloxanes; and

a carbon black coat formed on said coating layer comprising said organosilicon compound, in an amount of 26 to 55 parts by weight based on 100 parts by weight of said hematite particles or iron oxide hydroxide particles.

### CROSS REFERENCE TO RELATED APPLICATION

This is a continuation-in-part of application, Ser. No. 09/635,424 filed Aug. 10, 2000, which is a continuation-in-part of application, Serial No. 09/553,546 filed Apr. 20, 2000, which is a continuation-in-part of application, Serial No. 09/276,519 filed Mar. 25, 1999.

### BACKGROUND OF THE INVENTION

The present invention relates to a black toner comprising black non-magnetic composite particles which are not only excellent in dispersibility in a binder resin due to a less amount of carbon black desorbed or fallen-off from the surfaces thereof, but also have more excellent fluidity and blackness; and having more excellent fluidity and blackness as well as a high resistivity value.

In conventional electrophotographic developing processes, a black toner prepared by mixing and dispersing non-magnetic black pigments such as carbon black fine particles in a binder resin, has been widely used as a developer.

Recent developing systems have been generally classified into one-component developing methods and two-component developing methods.

In the two-component developing methods, the black toner and carrier are brought into frictional contact with each other to impart an electrostatic charge having a reverse sign to that of an electrostatic latent image to the black toner, so that the black toner is attached onto the surface of the electrostatic latent image due to an electrostatic attracting force therebetween, thereby neutralizing opposite electrostatic charges on the black toner and the electrostatic latent image.

On the other hand, in the one-component developing methods, since no carrier is used therein, it is not necessary to control a density of the black toner. Besides, a developing apparatus used therefor can be miniaturized due to its simple structure. However, since the one-component developing methods are inferior in developing performance or quality to the two-component developing methods, high techniques have now been required to obtain the same developing performance or quality as those of the two-component developing methods. As one of the one-component developing methods, there is known a so-called insulated non-magnetic toner developing method using a high-resistant or insulated black toner prepared by dispersing carbon black fine particles in a binder resin without using magnetic particles.

In the case where the black toners used in the above two-component developing method and the insulated non-magnetic toner developing method, are applied to a currently predominant PPC system of copiers, both types of the black toners are required to exhibit a good insulating property or a high resistance, specifically to have a volume resistivity as high as not less than 1×10¹³ Ω·cm.

Also, it is known that the behavior (movement) of a developer in a developing apparatus is strongly governed by the fluidity thereof, for example, the fluidity of the developer has strong influences on the frictional charging properties between the black toner and the carrier in the case of the two-component developing method, or on the charging property of the black toner on a sleeve in the case of the one-component developing method. Recently, with the enhancement in image quality such as image density, or tone gradation or in developing speed in the developing apparatus, it has been strongly demanded to increase the fluidity of the black toner.

With the recent tendency of reducing a particle size of the black toner, it has been more strongly required to enhance the fluidity thereof.

With respect to such a fact, in “Comprehensive Data Collection for Development and Utilization of Toner Materials”, published by Japan Scientific Information Co., Ltd., page 121, it has been described that “With extensive development of printers such as IPC, a high image quality has been required. In particular, it has been demanded to develop high-precision or high-definition printers. In Table 1, there is shown a relationship between image definitions obtained by using various toners. As is apparent from Table 1, the smaller the particle size of wet toner, the higher the image definition becomes. When a dry toner is used, it is also required to reduce the particle size of the toner for enhancing the image definition . . . As to toners having a small particle size, it has been reported that by using toners having a particle size of 8.5 to 11 μm, fogs on a background area as well as toner consumption can be reduced. Further, it has been proposed that by using polyester-based toners having a particle size of 6 to 10 μm, an image quality, a charging stability and lifetime of the developer can be improved. However, when such toners having a small particle size are used, it has been required to solve many problems, e.g., those problems concerning productivity, sharpness of particle size distribution, improvement in fluidity, etc.”.

Also, the black toner has been required to show a high blackness and a high image density of line images and solid area images on copies.

With respect to this fact, on page 272 of the above-mentioned “Comprehensive Data Collection for Development and Utilization of Toner Materials”, it has been described that “Powder development is characterized by a high image density. However, the image density as well as the fog density as described hereinafter, have strong influences on image characteristics”.

As described above, it has been strongly demanded to enhance various properties of the black toner. It is known that the black toner, especially black pigments exposed to the surface of the black toner, have large influences on developing characteristics. There is a close relationship between properties of the black toner and those of the black pigments mixed and dispersed in the black toner.

That is, the fluidity of the black toner considerably depends upon the surface condition of the black pigments exposed to the surface of the black toner. Therefore, the black pigments themselves have been strongly required to show an excellent fluidity. Further, the blackness and density of the black toner also considerably depend upon the blackness and density of the black pigments contained in the black toner.

At present, as the black pigments for black toner, there may be mainly used carbon black fine particles (Japanese Patent No. 2715336 and Japanese Patent Application Laid-Open (KOKAI) No. 10-39546(1998)).

There have now been most strongly demanded black non-magnetic particles for black toner which can show not only more excellent fluidity and blackness, but also an excellent dispersibility in a binder resin. However, such black non-magnetic particles capable of satisfying all of these properties have not been obtained.

Namely, in the case where the above-mentioned carbon black fine particles are used as the black particles for black toner, the amount of the carbon black fine particles used must be restricted in order to obtain a black toner having a volume resistivity of not less than 1×10¹³ Ω·cm. For this reason, there arises a problem that a sufficient blackness and a sufficient fluidity cannot be obtained.

The above conventional problems are explained more specifically below.

Due to the fact that the carbon black fine particles themselves are conductive materials, when a large amount of the carbon black fine particles are added and mixed in the black toner in order to enhance the blackness thereof, the volume resistivity of the black toner is remarkably decreased because the carbon black fine particles having a specific cluster-like structure are present on the surface of each black toner particle. As a result, the toner is no longer usable as an insulating or high-resistant toner. Conversely, when the amount of the carbon black fine particles contained in the black toner is reduced to increase the volume resistivity value of the black toner, the obtained black toner tends to be deteriorated in not only blackness but also fluidity. This is because the carbon black fine particles are buried inside each black toner particle due to the fineness of the carbon black fine particles having an average particle size as small as 0.010 to 0.060 μm, and, therefore, the amount of the carbon black fine particles exposed to the surface of each toner particle is reduced.

In addition, the carbon black fine particles have a specific gravity as low as 1.80 to 1.85, resulting in poor handing property of the carbon black fine particles. Further, when such carbon black fine particles are dispersed in a binder resin, the obtained black toner has merely a low bulk density. Such a black toner tends to be scattered around and deteriorated in fluidity.

As a result of the present inventors' earnest studies for solving the above problems, it has been found that by using as non-magnetic particles for a black toner, black non-magnetic composite particles having an average particle size of 0.06 to 1.0 μm, which comprise hematite particles or iron oxide hydroxide particles; a coating layer formed on the surface of the hematite particles or iron oxide hydroxide particles, comprising organosilicon compounds; and a single carbon black coat formed at least a part of the surface of the coating layer in an amount of 26 to 55 parts by weight based on 100 parts by weight of the hematite particles or iron oxide hydroxide particles , the obtained black toner is not only more excellent in fluidity and blackness, but also can exhibit a high resistivity value. The present invention has been attained on the basis of the finding.

### SUMMARY OF THE INVENTION

It is an object of the present invention to provide a black toner which is not only more excellent in fluidity and blackness, but also exhibits a high resistivity value.

It is an another object of the present invention to provide black non-magnetic composite particles for black toner, which are not only more excellent in fluidity and blackness, but also can show an excellent dispersibility in a binder resin.

To accomplish the aims, in a first aspect of the present invention, there is provided a black toner comprising:

a binder resin; and

black non-magnetic composite particles having an average particle diameter of 0.06 to 1.0 μm, comprising:

hematite particles or iron oxide hydroxide particles as core particles;

a coating layer formed on the surface of the hematite particles or iron oxide hydroxide particles, comprising at least one organosilicon compound selected from the group consisting of:

(1) organosilane compounds obtained from an alkoxysilane compounds, and

(2) polysiloxanes or modified polysiloxanes; and

a single carbon black coat formed on the coating layer comprising the organosilicon compound, in an amount of 26 to 55 parts by weight based on 100 parts by weight of the hematite particles or iron oxide hydroxide particles.

In a second aspect of the present invention, there is provided a black toner comprising:

black non-magnetic composite particles having an average particle diameter of 0.06 to 1.0 μm, comprising:

hematite particles or iron oxide hydroxide particles as core particles;

a coat formed on at least a part of the surface of the hematite particles or iron oxide hydroxide particles and comprising at least one compound selected from the group consisting of hydroxides of aluminum, oxides of aluminum, hydroxides of silicon and oxides of silicon in an amount of 0.01 to 50% by weight, calculated as Al or SiO₂, based on the total weight of the hematite particles or iron oxide hydroxide particles;

a coating layer formed on the said coat formed the surface of the hematite particles or iron oxide hydroxide particles, comprising at least one organosilicon compound selected from the group consisting of:

(1) organosilane compounds obtained from an alkoxysilane compounds, and

(2) polysiloxanes or modified polysiloxanes; and

a single carbon black coat formed on the coating layer comprising the organosilicon compound, in an amount of 26 to 55 parts by weight based on 100 parts by weight of the hematite particles or iron oxide hydroxide particles.

In a third aspect of the present invention, there is provided a method of using black non-magnetic composite particles for production of a black toner, comprising mixing the black non-magnetic composite particles with a binder resin,

which black non-magnetic composite particles having an average particle diameter of 0.06 to 1.0 μm, comprising:

hematite particles or iron oxide hydroxide particles as core particles;

a coating layer formed on the surface of the hematite particles or iron oxide hydroxide particles, comprising at least one organosilicon compound selected from the group consisting of:

(1) organosilane compounds obtained from an alkoxysilane compounds, and

(2) polysiloxanes or modified polysiloxanes; and

a single carbon black coat formed on the coating layer comprising the organosilicon compound, in an amount of 26 to 55 parts by weight based on 100 parts by weight of the hematite particles or iron oxide hydroxide particles.

In a fourth aspect of the present invention, there are provided black non-magnetic composite particles for a black toner,

which have an average particle diameter of 0.06 to 1.0 μm and a sphericity of from 1 to less than 2, and comprise:

hematite particles or iron oxide hydroxide particles as core particles;

a coating layer formed on the surface of the hematite particles or iron oxide hydroxide particles, comprising at least one organosilicon compound selected from the group consisting of:

(1) organosilane compounds obtained from an alkoxysilane compounds, and

(2) polysiloxanes or modified polysiloxanes; and

a single carbon black coat formed on the coating layer comprising the organosilicon compound, in an amount of 26 to 55 parts by weight based on 100 parts by weight of the hematite particles or iron oxide hydroxide particles.

In a fifth aspect of the present invention, there are provided black non-magnetic composite particles for a black toner,

which have an average particle diameter of 0.06 to 1.0 μm and a sphericity of from 1 to less than 2, and comprise:

hematite particles or iron oxide hydroxide particles as core particles;

a coat formed on at least a part of the surface of the hematite particles or iron oxide hydroxide particles and comprising at least one compound selected from the group consisting of hydroxides of aluminum, oxides of aluminum, hydroxides of silicon and oxides of silicon in an amount of 0.01 to 50% by weight, calculated as Al or SiO₂, based on the total weight of the hematite particles or iron oxide hydroxide particles;

a coating layer formed on the said coat formed on the surface of the hematite particles or iron oxide hydroxide particles, comprising at least one organosilicon compound selected from the group consisting of:

(1) organosilane compounds obtained from an alkoxysilane compounds, and

(2) polysiloxanes or modified polysiloxanes; and

a single carbon black coat formed on the coating layer comprising the organosilicon compound, in an amount of 26 to 55 parts by weight based on 100 parts by weight of the hematite particles or iron oxide hydroxide particles.

### DETAILED DESCRIPTION OF THE INVENTION

The present invention will be described in detail below.

First, the black non-magnetic composite particles as one constituent of the black toner according to the present invention, are explained.

The black non-magnetic composite particles used in the present invention are black non-magnetic composite particles having an average particle size of 0.06 to 1.0 μm, which comprise hematite particles or iron oxide hydroxide particles as core particles; a coating layer formed on the surface of the hematite particles or iron oxide hydroxide particles, comprising organosilicon compound; and a single carbon black coat formed on at least a part of the surface of the coating layer in a large amount.

As the core particles used in the present invention, there may be exemplified hematite particles, iron oxide hydroxide particles or mixed particles thereof. In the consideration of blackness of the obtained black non-magnetic composite particles, black hematite particles, black iron oxide hydroxide particles or mixed particles thereof are preferred. As the iron oxide hydroxide particles, there may be exemplified goethite particles, lepidocrosite particles.

As the black hematite particles, there may be exemplified manganese-containing hematite particles which contain manganese in an amount of 5 to 40% by weight (calculated as Mn) based on the weight of the manganese-containing hematite particles. As the black iron oxide hydroxide particles, there may be exemplified manganese-containing iron oxide hydroxide particles such as manganese-containing goethite particles, which contain manganese in an amount of 5 to 40% by weight (calculated as Mn) based on the weight of the manganese-containing iron oxide hydroxide particles.

The core particles may be in the form of either isotropic particles having a sphericity (ratio of an average particle length to an average particle breadth; hereinafter referred to merely as “sphericity”) of not less than 1.0:1 and less than 2.0:1, such as spherical particles, granular particles or polyhedral particles, e.g., hexahedral particles or octahedral particles; or anisotropic particles having an aspect ratio (ratio of average major axial diameter to average minor axial diameter; hereinafter referred to merely as “aspect ratio”) of not less than 2.0:1, such as acicular particles, spindle-shaped particles or rice grain-shaped particles. In the consideration of the fluidity of the obtained black non-magnetic composite particles, the use of the isotropic particles is preferred, and the use of the spherical particles and the granular particles is more preferred.

In the case of the isotropic hematite particles or iron oxide hydroxide particles as core particles, the average particle size (diameter) thereof is 0.055 to 0.95 μm, preferably 0.065 to 0.75 μm, more preferably 0.065 to 0.45 μm. The sphericity thereof is usually not less than 1.0:1 and less than 2.0:1, preferably 1.0:1 to 1.8:1, more preferably 1.0:1 to 1.6:1.

In the case of the anisotropic hematite particles or iron oxide hydroxide particles as core particles, the average major axial diameter thereof is 0.055 to 0.95 μm, preferably 0.065 to 0.75 μm, more preferably 0.065 to 0.45 μm. The aspect ratio thereof is 2.0:1 to 20.0:1, preferably 2.0:1 to 18.0:1, more preferably 2.0:1 to 15.0:1.

When the average particle size of the hematite particles or iron oxide hydroxide particles is more than 0.95 μm, the obtained black non-magnetic composite particles are coarse particles and are deteriorated in tinting strength. On the other hand, when the average particle size is less than 0.055 μm, the intermolecular force between the particles is increased due to the reduction in particle diameter, so that agglomeration of the particles tends to be caused. As a result, it becomes difficult to uniformly coat the surface of the hematite particles or iron oxide hydroxide particles with the organosilicon compounds, and uniformly form the carbon black coat on the surface of the coating layer comprising the organosilicon compounds.

When the core particles have an anisotropic shape, and the upper limit of the aspect ratio is more than 20:1, the particles tend to be entangled with each other. As a result, it is difficult to form a uniform coating layer comprising the organosilicon compounds on the surfaces of the core particles and uniformly form carbon black coat onto the surface of the coating layer.

As to the particle diameter distribution of the hematite particles or iron oxide hydroxide particles, the geometrical standard deviation value thereof is preferably not more than 2.0, more preferably not more than 1.8, still more preferably not more than 1.6. When the geometrical standard deviation value thereof is more than 2.0, coarse particles are contained therein, so that the particles are inhibited from being uniformly dispersed. As a result, it also becomes difficult to uniformly coat the surfaces of the hematite particles or iron oxide hydroxide particles with the organosilicon compounds, and uniformly form the single carbon black coat on the surface of the coating layer composed of the organosilicon compounds. The lower limit of the geometrical standard deviation value is 1.01. It is industrially difficult to obtain particles having a geometrical standard deviation value of less than 1.01.

The BET specific surface area of the hematite particles or iron oxide hydroxide particles thereof is not less than 0.5 m²/g. When the BET specific surface area is less than 0.5 m²/g, the hematite particles or iron oxide hydroxide particles may become coarse particles, or the sintering between the particles may be caused, so that the obtained black non-magnetic composite particles also may become coarse particles and tend to be deteriorated in tinting strength. In the consideration of the tinting strength of the obtained black non-magnetic composite particles, the BET specific surface area of the hematite particles or iron oxide hydroxide particles is preferably not less than 1.0 m²/g, more preferably 1.5 m²/g. Further, in the consideration of uniformly coating the surfaces of the hematite particles or iron oxide hydroxide particles with the organosilicon compounds, and uniformly forming the single carbon black coat on the coating layer composed of the organosilicon compounds, the upper limit of the BET specific surface area of the hematite particles or iron oxide hydroxide particles, is usually 190 m²/g, preferably 140 m²/g, more preferably 90 m²/g.

As to the fluidity of the hematite particles or iron oxide hydroxide particles, the fluidity index thereof is about 25 to about 42. Among the hematite particles or iron oxide hydroxide particles having various shapes, the spherical particles are excellent in fluidity, for example, the fluidity index thereof is about 30 to about 42.

As to the blackness of the core particles, in the case of the hematite particles, the lower limit thereof is usually 18.0 when represented by L* value, and the upper limit thereof is usually 36.0, preferably 34.0 when represented by L* value. In the case of the iron oxide hydroxide particles such as the goethite particles, the lower limit thereof is usually 18.0 when represented by L* value, and the upper limit thereof is usually 38.0, preferably 36.0 when represented by L* value.

In the case of the black hematite particles such as the manganese-containing hematite particles, the lower limit thereof is usually 18.0 when represented by L* value, and the upper limit thereof is usually 28.0, preferably 25.0 when represented by L* value. In the case of the black iron oxide hydroxide particles such as the manganese-containing goethite particles, the lower limit thereof is usually 18.0 when represented by L* value, and the upper limit thereof is usually 30.0, preferably 28.0 when represented by L* value.

When the L* value exceeds the above-mentioned upper limit, the lightness of the particles is increased, so that it is difficult to obtain black non-magnetic composite particles having a sufficient blackness.

As the core particle, there may be used hematite particles or iron oxide hydroxide particles wherein at least a part of the surface of the hematite particle or iron oxide hydroxide particle is preliminarily coated with at least one compound selected from the group consisting of hydroxides of aluminum, oxides of aluminum, hydroxides of silicon and oxides of silicon (hereinafter referred to as “hydroxides and/or oxides of aluminum and/or silicon”). In this case, the dispersibility of the obtained composite particles in a vehicle may become improved as compared to those having no undercoat composed of hydroxides and/or oxides of aluminum and/or silicon, because the percentage of desorption of carbon black from the black non-magnetic composite particles is lessened.

The amount of the coat composed of hydroxides and/or oxides of aluminum and/or silicon is preferably 0.01 to 50% by weight (calculated as Al, SiO₂ or a sum of Al and SiO₂) based on the weight of the hematite particles or iron oxide hydroxide particles as core particles.

When the amount of the hydroxides and/or oxides of aluminum and/or silicon coat is less than 0.01% by weight, the effect of enhancing the dispersibility of the obtained black non-magnetic composite particles in a binder resin upon the production of black toner may not be obtained, because of failing to achieve the improvement of lessening the percentage of desorption of carbon black therefrom. On the other hand, when the amount of the hydroxides and/or oxides of aluminum and/or silicon coat is more than 50% by weight, the obtained black non-magnetic composite particles can exhibit a good dispersibility in a binder resin upon the production of black toner by the improvement of lessening the percentage of desorption of carbon black therefrom. However, the coating effect is saturated and, therefore, it is meaningless to add such an excess amount of the hydroxides and/or oxides of aluminum and/or silicon coat.

The coating formed on the surfaces of the core particles comprises at least one organosilicon compound selected from the group consisting of (1) organosilane compounds obtainable from alkoxysilane compounds; (2) polysiloxanes, and (2′) modified polysiloxanes selected from the group consisting of (A) polysiloxanes modified with at least one compound selected from the group consisting of polyethers, polyesters and epoxy compounds (hereinafter referred to merely as “modified polysiloxanes”), and (B) polysiloxanes whose molecular terminal is modified with at least one group selected from the group consisting of carboxylic acid groups, alcohol groups and a hydroxyl group (hereinafter referred to merely as “terminal-modified polysiloxanes”).

The organosilane compounds (1) may be produced by drying or heat-treating alkoxysilane compounds represented by the formula (I):

R¹ₐSiX₄₋ₐ (I)

wherein R¹ is C₆H₅—, (CH₃)₂CHCH₂— or n-C_{b}H_{2b+1}— (wherein b is an integer of 1 to 18); X is CH₃O— or C₂H₅O—; and a is an integer of 0 to 3.

The drying or heat-treatment of the alkoxysilane compounds may be conducted, for example, at a temperature of usually 40 to 200° C., preferably 60 to 150° C. for usually 10 minutes to 12 hours, preferably 30 minutes to 3 hours.

Specific examples of the alkoxysilane compounds may include methyltriethoxysilane, dimethyldiethoxysilane, phenyltriethyoxysilane, diphenyldiethoxysilane, methyltrimethoxysilane, dimethyldimethoxysilane, phenyltrimethoxysilane, diphenyldimethoxysilane, isobutyltrimethoxysilane, decyltrimethoxysilane or the like. Among these alkoxysilane compounds, in view of the desorption percentage and the adhering effect of carbon black, methyltriethoxysilane, phenyltriethyoxysilane, methyltrimethoxysilane, dimethyldimethoxysilane and isobutyltrimethoxysilane are preferred, and methyltriethoxysilane and methyltrimethoxysilane are more preferred.

As the polysiloxanes (2), there may be used those compounds represented by the formula (II):

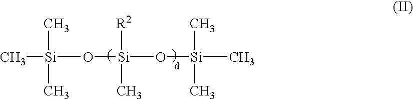

wherein R² is H— or CH₃—, and d is an integer of 15 to 450.

Among these polysiloxanes, in view of the desorption percentage and the adhering effect of carbon black, polysiloxanes having methyl hydrogen siloxane units are preferred.

As the modified polysiloxanes (2′-A), there may be used:

(a) polysiloxanes modified with polyethers represented by the formula (III):

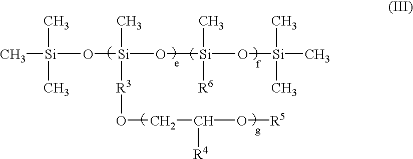

wherein R³ is —(—CH₂—)ₕ—; R⁴ is —(—CH₂—)ᵢ—CH₃; R⁵ is —OH, —COOH, —CH═CH₂, —C(CH₃)═CH₂ or —(—CH₂—)ⱼ—CH₃; R⁶ is —(—CH₂—)ₖ—CH₃; g and h are an integer of 1 to 15; i, j and k are an integer of 0 to 15; e is an integer of 1 to 50; and f is an integer of 1 to 300;

(b) polysiloxanes modified with polyesters represented by the formula (IV):

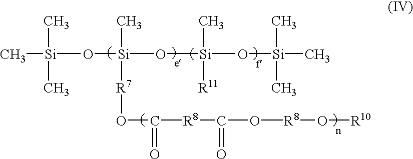

wherein R⁷, R⁸ and R⁹ are —(—CH₂—)_{q}— and may be the same or different; R¹⁰ is —OH, —COOH, —CH═CH₂, —C(CH₃)═CH₂ or —(—CH₂—)ᵣ—CH₃; R¹¹ is —(—CH₂—)ₛ—CH₃; n and q are an integer of 1 to 15; r and s are an integer of 0 to 15; e′ is an integer of 1 to 50; and f′ is an integer of 1 to 300;

(c) polysiloxanes modified with epoxy compounds represented by the formula (V):

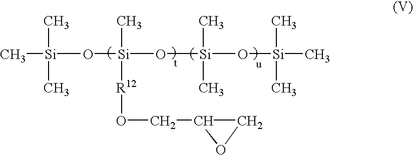

wherein R¹² is —(—CH₂—)ᵥ—; v is an integer of 1 to 15; t is an integer of 1 to 50; and u is an integer of 1 to 300; or a mixture thereof.

Among these modified polysiloxanes (2′-A), in view of the desorption percentage and the adhering effect of carbon black, the polysiloxanes modified with the polyethers represented by the formula (III), are preferred.

As the terminal-modified polysiloxanes (2′-B), there may be used those represented by the formula (VI):

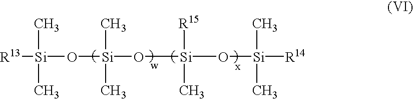

wherein R¹³ and R¹⁴ are —OH, R¹⁶OH or R¹⁷COOH and may be the same or different; R¹⁵ is —CH₃ or —C₆H₅; R¹⁶ and R¹⁷ are —(—CH₂—)_{y}—; y is an integer of 1 to 15; w is an integer of 1 to 200; and x is an integer of 0 to 100.

Among these terminal-modified polysiloxanes, in view of the desorption percentage and the adhering effect of carbon black, the polysiloxanes whose terminals are modified with carboxylic acid groups are preferred.

The amount of the coating layer composed of the organosilicon compounds is usually 0.02 to 5.0% by weight, preferably 0.03 to 4.0% by weight, more preferably 0.05 to 3.0% by weight (calculated as Si) based on the weight of the hematite particles or iron oxide hydroxide particles coated with the organosilicon compounds.

When amount of the coating layer composed of the organosilicon compounds is less than 0.02% by weight, it becomes difficult to adhere the carbon black on the surfaces of the hematite particles or iron oxide hydroxide particles. On the other hand, when the coating amount of the organosilicon compounds is more than 5.0% by weight, since the single carbon black coat can be sufficiently formed on the surface of the coating layer composed of the organosilicon compounds, it is meaningless to coat an excess amount of the organosilicon compounds.

A single carbon black coat is formed on at least a part of the surface of coating layer composed of the organosilicon compounds.

In the present invention, the amount of the single carbon black coat is 26 to 55 parts by weight based on 100 parts by weight of the core particles.

When the amount of the single carbon black coated is more than 55 parts by weight, the desorption percentage of the carbon black is increased, resulting in poor dispersibility in a binder resin upon production of the black toner.

The thickness of the single carbon black coat is preferably not more than 0.06 μm, more preferably not more than 0.05 μm, still more preferably 0.04 μm. The lower limit thereof is more preferably 0.0001 μm.

The particle shape and particle size of the black non-magnetic composite particles used in the present invention are considerably varied depending upon those of the hematite particles or iron oxide hydroxide particles as core particles. The black non-magnetic composite particles have a similar particle shape to that of the hematite particles or iron oxide hydroxide particles as core particle, and a slightly larger particle size than that of the hematite particles or iron oxide hydroxide particles as core particles.

More specifically, when the isotropic hematite particles or iron oxide hydroxide particles are used as core particles, the obtained black non-magnetic composite particles used in the present invention, have an average particle size of usually 0.06 to 1.0 μm, preferably 0.07 to 0.8 μm, more preferably 0.07 to 0.5 μm and a sphericity of usually from not less than 1.0:1 and less than 2.0:1, preferably 1.0:1 to 1.8:1, more preferably 1.0:1 to 1.6:1.

When the anisotropic hematite particles or iron oxide hydroxide particles are used as core particles, the lower limit of the average particle diameter of the obtained black non-magnetic composite particles used in the present invention, is usually 0.06 μm, preferably 0.07 μm, and the upper limit of average particle diameter thereof is usually 1.0 μm, preferably 0.8 μm, more preferably 0.5 μm. In addition, the aspect ratio of the obtained black non-magnetic composite particles according to the present invention, is usually 2.0:1 to 20.0:1, preferably 2.0:1 to 18.0:1, more preferably 2.0:1 to 15.0:1.

When the average particle size of the black non-magnetic composite particles is more than 1.0 μm, the obtained black non-magnetic composite particles may be coarse particles, and deteriorated in tinting strength. On the other hand, when the average particle diameter thereof is less than 0.06 μm, the black non-magnetic composite particles tends to be agglomerated by the increase of intermolecular force due to the reduction in particle size, thereby deteriorating the dispersibility in a binder resin upon production of the black toner.

When the aspect ratio is more than 20.0:1, the black non-magnetic composite particles may be entangled with each other in the binder resin, so that the dispersibility in binder resin upon the production of the black toner tends to be deteriorated.

The geometrical standard deviation value of the black non-magnetic composite particles used in the present invention is preferably not more than 2.0, more preferably not more than 1.8, still more preferably not more than 1.6. The lower limit of the geometrical standard deviation value thereof is preferably 1.01. When the geometrical standard deviation value thereof is more than 2.0, the tinting strength of the black non-magnetic composite particles is likely to be deteriorated due to the existence of coarse particles therein. It is industrially difficult to obtain such particles having a geometrical standard deviation of less than 1.01.

The BET specific surface area of the black non-magnetic composite particles used in the present invention, is usually 1.0 to 200 m²/g, preferably 1.5 to 150 m²/g, more preferably 2.0 to 100 m²/g. When the BET specific surface area thereof is less than 1.0 m²/g, the obtained black non-magnetic composite particles may be coarse, and the sintering between the particles is caused, thereby deteriorating the tinting strength. On the other hand, when the BET specific surface area is more than 200 m²/g, the black non-magnetic composite particles tend to be agglomerated together by the increase in intermolecular force due to the reduction in particle size, thereby deteriorating the dispersibility in a binder resin upon production of the black toner.

As to the fluidity of the black non-magnetic composite particles used in the present invention, the fluidity index thereof is preferably 48 to 90, more preferably 49 to 90, still more preferably 50 to 90. When the fluidity index thereof is less than 48, the fluidity of the black non-magnetic composite particles becomes insufficient, thereby failing to improve the fluidity of the finally obtained black toner. Further, in the production process of the black toner, there tend to be caused defects such as clogging of hopper, etc., thereby deteriorating the handling property or workability.

As to the blackness of the black non-magnetic composite particles used in the present invention, in the case the hematite particles are used as core particles, the upper limit of the blackness of the black non-magnetic composite particles is usually 19.5, preferably 18.8, more preferably 18.3 when represented by L* value. In the case the iron oxide hydroxide particles such as the goethite particles are used as core particles, the upper limit of the blackness of the black non-magnetic composite particles is usually 19.5, preferably 19.3, more preferably 18.8 when represented by L* value.

In the case the black hematite particles such as the manganese-containing hematite particles are used as core particles, the upper limit of the blackness of the black non-magnetic composite particles is usually 19.5, preferably 18.3, more preferably 17.8 when represented by L* value. In the case the black iron oxide hydroxide particles such as the manganese-containing goethite particles are used as core particles, the upper limit of the blackness of the black non-magnetic composite particles is usually 19.5, preferably 18.8, more preferably 18.3 when represented by L* value.

When the L* value thereof is more than 19.5, the lightness of the obtained black non-magnetic composite particles becomes high, so that the black non-magnetic composite particles having a sufficient blackness cannot be obtained. The lower limit of the blackness thereof is 15 when represented by L* value.

The dispersibility in binder resin of the black non-magnetic composite particles used in the present invention, is preferably 4th or 5th rank, more preferably 5th rank when evaluated by the method described hereinafter.

The percentage of desorption of carbon black from the black non-magnetic composite particles used in the present invention, is preferably not more than 20%, more preferably not more than 10%. When the desorption percentage of the carbon black is more than 20%, the desorbed carbon black tend to inhibit the black non-magnetic composite particles from being uniformly dispersed in the binder resin upon production of the black toner.

In the black non-magnetic composite particles used in the present invention, when at least a part of the surface of the hematite particle or iron oxide hydroxide particle as core particle may be preliminarily coated with hydroxides and/or oxides of aluminum and/or silicon, the obtained black non-magnetic composite particles can show a higher dispersibility in a binder resin as compared to in the case where the hematite particles or iron oxide hydroxide particles are uncoated with hydroxides and/or oxides of aluminum and/or silicon, because of achieving the improvement of lessening the percentage of desorption of carbon black therefrom.

The black non-magnetic composite particles using as core particles the hematite particle or iron oxide hydroxide particle having the coat composed of the hydroxides and/or oxides of aluminum and/or silicon may be substantially identical in a particle size, a geometrical standard deviation, a BET specific surface area, a blackness (L* value), a fluidity and a magnetic property, to those having no hydroxides and/or oxides of aluminum and/or silicon coat.

By coating the core particle with the hydroxides and/or oxides of aluminum and/or silicon, the percentage of desorption of carbon black from the obtained black non-magnetic composite particles of the present invention is preferably not more than 10%, more preferably not more than 5%.

Next, the black toner according to the present invention is described.

The black toner according to the present invention comprises the black non-magnetic composite particles and a binder resin. The black toner may further contain a mold release agent, a colorant, a charge-controlling agent and other additives, if necessary.

The black toner according to the present invention has an average particle size of usually 3 to 25 μm, preferably 4 to 18 μm, more preferably 5 to 15 μm.

The amount of the binder resin used in the black toner is usually 50 to 3500 parts by weight, preferably 50 to 2000 parts by weight, more preferably 50 to 1000 parts by weight based on 100 parts by weight of the black non-magnetic composite particles.

As the binder resins, there may be used vinyl-based polymers, i.e., homopolymers or copolymers of vinyl-based monomers such as styrene, alkyl acrylates and alkyl methacrylates. As the styrene monomers, there may be exemplified styrene and substituted styrenes. As the alkyl acrylate monomers, there may be exemplified acrylic acid, methyl acrylate, ethyl acrylate, butyl acrylate or the like.

It is preferred that the above copolymers contain styrene-based components in an amount of usually 50 to 95% by weight.

In the binder resin used in the present invention, the above-mentioned vinyl-based polymers may be used in combination with polyester-based resins, epoxy-based resins, polyurethane-based resins or the like.

As to the fluidity of the black toner according to the present invention, the fluidity index is usually 78 to 100, preferably 79 to 100, more preferably 80 to 100. When the fluidity index is less than 78, the black toner may not show a sufficient fluidity.

The blackness of the black toner according to the present invention is usually not more than 19.0, preferably not more than 18.8, more preferably not more than 18.5 when represented by L* value. When the blackness thereof is more than 19.0, the lightness of the black toner may be increased, resulting in insufficient blackness. The lower limit of the blackness of the black toner is usually about 15 when represented by L* value.

The volume resistivity of the black toner according to the present invention, is usually not less than 1.0×10¹³ Ω·cm, preferably not less than 3.0×10¹³ Ω·cm, more preferably not less than 5.0×10¹³ Ω·cm. When the volume resistivity is less than 1.0×10¹³ Ω·cm, the charge amount of the black toner tends to vary depending upon environmental conditions in which the toner is used, resulting in unstable properties of the black toner. The upper limit of the volume resistivity thereof is 1.0×10¹⁷ Ω·cm.

The black non-magnetic composite particles according to the present invention can be produced by the following method.

The granular hematite particles as the isotropic core particles used in the present invention can be produced by heating, in air at a temperature of 750 to 1,000° C., granular magnetite particles which are obtained by a so-called wet oxidation method, i.e., by passing an oxygen-containing gas through a suspension containing a ferrous hydroxide colloid obtained by reacting an aqueous ferrous salt solution with alkali hydroxide.

The granular manganese-containing hematite particles as the isotropic core particles used in the present invention, can be produced by heating, in air at a temperature of 750 to 1,000° C., (a) coated magnetite particles which are obtained by first producing granular magnetite particles by a so-called wet oxidation method, i.e., by passing an oxygen-containing gas through a suspension containing a ferrous hydroxide colloid obtained by reacting an aqueous ferrous salt solution with alkali hydroxide, and then coating the obtained granular magnetite particles with a manganese compound in an amount of 8 to 150 atm % (calculated as Mn) based on whole Fe, or (b) magnetite particles containing manganese in an amount of 8 to 150 atm % (calculated as Mn) based on whole Fe, which are obtained by conducting the above wet oxidation method in the presence of manganese. In the consideration of blackness of the obtained manganese-containing hematite particles, it is preferred to use the manganese-containing magnetite particles (b).

The acicular or spindle-shaped hematite particles as the anisotropic core particles used in the present invention, can be produced by heating acicular or spindle-shaped iron oxide hydroxide particles obtained by the method described hereinafter, in air at a temperature of 400 to 800° C.

The acicular or spindle-shaped iron oxide hydroxide particles as the anisotropic core particles used in the present invention, can be produced by passing an oxygen-containing gas through a suspension containing either ferrous hydroxide colloid, iron carbonate or iron-containing precipitates obtained by reacting an aqueous ferrous salt solution with alkali hydroxide, alkali carbonate or both of alkali hydroxide and alkali carbonate, and then subjecting the obtained iron oxide hydroxide particles to filtration, washing with water and drying.

The acicular or spindle-shaped manganese-containing hematite particles as the anisotropic core particles used in the present invention, can be produced by heating, in air at a temperature of 400 to 800° C., acicular or spindle-shaped iron oxide hydroxide particles containing manganese in an amount of 8 to 150 atomic % based on whole Fe, which are obtained by the method described hereinafter.

The acicular or spindle-shaped manganese-containing iron oxide hydroxide particles as the anisotropic core particles used in the present invention, can be produced by passing an oxygen-containing gas through a suspension containing either ferrous hydroxide colloid, iron carbonate or iron-containing precipitates obtained by reacting an aqueous ferrous salt solution with alkali hydroxide, alkali carbonate or both of alkali hydroxide and alkali carbonate, in the presence of manganese in an amount of 8 to 150 atm % (calculated as Mn) based on whole Fe, and then subjecting the obtained iron oxide hydroxide particles to filtration, washing with water and drying.

The coating of the hematite particles or iron oxide hydroxide particles with the alkoxysilane compounds, the polysiloxanes, the modified polysiloxanes or the terminal-modified polysiloxanes, can be conducted (i) by mechanically mixing and stirring the hematite particles or iron oxide hydroxide particles together with the alkoxysilane compounds, the polysiloxanes, the modified polysiloxanes or the terminal-modified polysiloxanes; or (ii) by mechanically mixing and stirring both the components together while spraying the alkoxysilane compounds, the polysiloxanes, the modified polysiloxanes or the terminal-modified polysiloxanes onto the hematite particles or iron oxide hydroxide particles. In these cases, substantially whole amount of the alkoxysilane compounds, the polysiloxanes, the modified polysiloxanes or the terminal-modified polysiloxanes added can be applied onto the surfaces-of the hematite particles or iron oxide hydroxide particles.

In order to uniformly coat the surfaces of the hematite particles or iron oxide hydroxide particles with the alkoxysilane compounds, the polysiloxanes, the modified polysiloxanes or the terminal-modified polysiloxanes, it is preferred that the hematite particles or iron oxide hydroxide particles are preliminarily diaggregated by using a pulverizer.

As apparatuses used for (a) mixing and stirring the core particles with alkoxysilane compounds, the polysiloxanes, the modified polysiloxanes or the terminal-modified polysiloxanes; (b) mixing and stirring the carbon black fine particles with the particles surface-coated with alkoxysilane compounds, the polysiloxanes, the modified polysiloxanes or the terminal-modified polysiloxanes, there may be preferably used apparatus capable of applying a shearing force to a layer of the particles to be treated, more preferably those capable of conducting shearing, spatula-stroking-and compression at the same time, for example, wheel-type kneader, ball-type kneader, blade-type kneader, roll-type kneader or the like. Among these apparatuses, the wheel-type kneader is more effective for the practice of the present invention.

Specific examples of the wheel-type kneaders may include an edge runner (equal to a mix muller, a Simpson mill or a sand mill), a multi-mull, a Stotz mill, a wet pan mill, a Conner mill, a ring muller, or the like. Among them, an edge runner, a multi-mull, a Stotz mill, a wet pan mill and a ring muller are preferred, and an edge runner is more preferred.

Specific examples of the ball-type kneaders may include a vibrating mill or the like. Specific examples of the blade-type kneaders may include a Henschel mixer, a planetary mixer, a Nawter mixer or the like. Specific examples of the roll-type kneaders may include an extruder or the like.

In order to coat the surfaces of the core particles with the alkoxysilane compounds, the polysiloxanes, the modified polysiloxanes or the terminal-modified polysiloxanes as uniformly as possible, the conditions of the above mixing or stirring treatment may be appropriately controlled such that the linear load is usually 19.6 to 1960 N/cm (2 to 200 Kg/cm), preferably 98 to 1470 N/cm (10 to 150 kg/cm), more preferably 147 to 980 N/cm (15 to 100 kg/cm); and the treating time is usually 5 to 120 minutes, preferably 10 to 90 minutes. It is preferred to appropriately adjust the stirring speed in the range of usually 2 to 2,000 rpm, preferably 5 to 1,000 rpm, more preferably 10 to 800 rpm.

The amount of the alkoxysilane compounds, the polysiloxanes, the modified polysiloxanes or the terminal-modified polysiloxanes added, is preferably 0.15 to 45 parts by weight based on 100 parts by weight of the hematite particles or iron oxide hydroxide particles. When the amount of the alkoxysilane compounds, the polysiloxanes, the modified polysiloxanes or the terminal-modified polysiloxanes added is less than 0.15 part by weight, it may become difficult to form the single carbon black coat on the coating layer.

On the other hand, when the amount of the alkoxysilane compounds, the polysiloxanes, the modified polysiloxanes or the terminal-modified polysiloxanes added is more than 45 parts by weight, a sufficient amount of the single carbon black coat can be formed on the surface of the coating, and therefore, it is meaningless to add such an excess amount of the alkoxysilane compounds, the polysiloxanes, the modified polysiloxanes or the terminal-modified polysiloxanes.

Meanwhile, a part of the alkoxysilanes coated on the surfaces of the core particles may be converted into the organosilane compounds via the coating step thereof. Even in such a case, the subsequent adhesion step with carbon black is not adversely affected.

Next, the carbon black fine particles are added to the hematite particles or iron oxide hydroxide particles coated with the polysiloxanes, the modified polysiloxanes or the terminal-modified polysiloxanes in an amount of 26 to 55 parts by weight based on 100 parts by weight of the hematite particles or iron oxide hydroxide particles, and the resultant mixture is mixed and stirred to form a single carbon black coat on the surfaces of the coating composed of the polysiloxanes, the modified polysiloxanes or the terminal-modified polysiloxanes added.

By varying an adding method of the carbon black fine particles, mixing and stirring conditions, it is possible to form the single carbon black coat on the coating layer composed of the organosilicon compounds, thereby rendering the coating process industrially disadvantageous.

As the adding method, a lump addition method, a continuous addition method, a divided addition method may be exemplified. When a large amount of the carbon black fine particles is added, it is preferred to conduct the continuous addition method and the divided addition method.

In case of continuously adding the carbon black fine particles, the carbon black fine particles may be added slowly and little by little, especially for a period of 5 minutes to 24 hours, preferably 5 minutes to 20 hours. The mixing and stirring step under the following conditions can be conducted.

In case of dividedly adding the carbon black fine particles, the adding step of the carbon black fine particles of 5 to 25 parts by weight based on 100 parts by weight of the hematite particles or iron oxide hydroxide particles as core particles. The mixing and stirring step under the following conditions can be repeated until the added amount of the carbon black fine particles reaches a predetermined amount thereof.

In order to form the single carbon black coat onto the coating layer composed of the alkoxysilane compounds, the polysiloxanes, the modified polysiloxanes or the terminal-modified polysiloxanes as uniformly as possible, the conditions of the above mixing or stirring treatment can be appropriately controlled such that the linear load is usually 19.6 to 1960 N/cm (2 to 200 Kg/cm), preferably 98 to 1470 N/cm (10 to 150 Kg/cm), more preferably 147 to 980 N/cm (15 to 100 Kg/cm); and the treating time is usually 5 minutes to 24 hours, preferably 10 minutes to 20 hours. It is preferred to appropriately adjust the stirring speed in the range of usually 2 to 2,000 rpm, preferably 5 to 1,000 rpm, more preferably 10 to 800 rpm.

The amount of the carbon black fine particles added for forming the single carbon black layer is usually 26 to 55 parts by weight based on 100 parts by weight of the core particles. When the amount of the carbon black fine particles added is more than 55 part by weight, the carbon black tends to be desorbed or fallen-off from the surfaces of the obtained black non-magnetic composite particles, resulting in deteriorated dispersibility in a binder resin upon production of the black toner.

As the carbon black fine particles used in the present invention, there may be exemplified commercially available carbon blacks such as furnace black, channel black or the like. Specific examples of the commercially available carbon blacks usable in the present invention, may include #3050, #3150, #3250, #3750, #3950, MA100, MA7, #1000, #2400B, #30, MA77, MA8, #650, MA11, #50, #52, #45, #2200B, MA600, etc. (tradename, produced by Mitsubishi Chemical Corp.), SEAST 9H, SEAST 7H, SEAST 6, SEAST 3H, SEAST 300, SEAST FM, etc. (tradename, produced by Tokai Carbon Co., Ltd.), Raven 1250, Raven 860 ULTRA, Raven 1000, Raven 1190 ULTRA, etc. (tradename, produced by Colombian Chemicals Company), Ketchen black EC, Ketchen black EC600JD, etc. (tradename, produced by Ketchen Black International Co., Ltd.), BLACK PEARLS-L, BLACK PEARLS 1000, BLACK PEARLS 4630, VULCAN XC72, REGAL 660, REGAL 400, etc. (tradename, produced by Cabott Specialty Chemicals Ink Co., Ltd.), or the like.

In the consideration of uniformly forming the single carbon black coat onto the coating composed of the alkoxysilane compounds, the polysiloxanes, the modified polysiloxanes or the terminal-modified polysiloxanes, or the dimethylpolysiloxane coating layer, the use of carbon black fine particles having a DBP oil absorption of not more than 150 ml/100 g is preferred. Specific examples of the commercially available carbon blacks usable in the present invention, may include MA100, MA7, #1000, #2400B, #30, MA77, MA8, #650, MA11, #50, #52, #45, #2200B, MA600, etc. (tradename, produced by MITSUBISHI CHEMICAL CORP.), SEAST 9H, SEAST 7H, SEAST 6, SEAST 3H, SEAST 300, etc. (tradename, produced by TOKAI CARBON CO., LTD.), Raven 1250, Raven 860 ULTRA, Raven 1000, Raven 1190 ULTRA, etc. (tradename, produced by COLOMBIAN CHEMICALS COMPANY), BLACK PEARLS-L, BLACK PEARLS 1000, BLACK PEARLS 4630, REGAL 660, REGAL 400, etc. (tradename, produced by CABOTT SPECIALTY CHEMICALS INK CO., LTD.).

The average particle size of the carbon black fine particles used is usually 0.002 to 0.05 μm, preferably 0.002 to 0.035 μm. When the average particle size of the carbon black fine particles used is less than 0.002 μm, the carbon black fine particles used are too fine to be well handled.

On the other hand, when the average particle size thereof is more than 0.05 μm, since the particle size of the carbon black fine particles used is much larger, it is necessary to apply a larger mechanical shear force for forming the uniform carbon black coat on the coating layer composed of the organosilicon compounds, thereby rendering the coating process industrially disadvantageous.

In the case where the alkoxysilane compounds are used as the coating compound, the resultant black non-magnetic composite particles may be dried or heat-treated, for example, at a temperature of usually 40 to 150° C., preferably 60 to 120° C. for usually 10 minutes to 12 hours, preferably 30 minutes to 3 hours, thereby forming a coating layer composed of the organosilane compounds. By the drying or heat-treatment, the alkoxysilane compounds on the surface of the core particle is converted to the organosilane compounds.

Meanwhile, the alkoxysilane used to coat the core particles in the thus obtained black magnetic composite particles is finally converted into the organosilane compound through the above mixing and stirring step and drying or heat-treating step.

At least a part of the surface of the hematite particles or iron oxide hydroxide particles may preliminary be coated with at least one compound selected from the group consisting of hydroxides of aluminum, oxides of aluminum, hydroxides of silicon and oxides of silicon, if required, prior to mixing and stirring with the alkoxysilane compounds, the polysiloxanes, the modified polysiloxanes or the terminal-modified polysiloxanes.

The coating of the hydroxides and/or oxides of aluminum and/or silicon may be conducted by adding an aluminum compound, a silicon compound or both the compounds to a water suspension in which the hematite particles or iron oxide hydroxide particles are dispersed, followed by mixing and stirring, and further adjusting the pH value of the suspension, if required, thereby coating the surfaces of the hematite particles or iron oxide hydroxide particles with at least one compound selected from the group consisting of hydroxides of aluminum, oxides of aluminum, hydroxides of silicon and oxides of silicon. The thus obtained particles coated with the hydroxides and/or oxides of aluminum and/or silicon are then filtered out, washed with water, dried and pulverized. Further, the particles coated with the hydroxides and/or oxides of aluminum and/or silicon may be subjected to post-treatments such as deaeration treatment and compaction treatment, if required.

As the aluminum compounds, there may be exemplified aluminum salts such as aluminum acetate, aluminum sulfate, aluminum chloride or aluminum nitrate, alkali aluminates such as sodium aluminate or the like.

The amount of the aluminum compound added is 0.01 to 50% by weight (calculated as Al) based on the weight of the hematite particles or iron oxide hydroxide particles. When the amount of the aluminum compound added is less than 0.01% by weight, it may be difficult to sufficiently coat the surfaces of the hematite particles or iron oxide hydroxide particles with hydroxides and/or oxides of aluminum, which can achieve the improvement of lessening the percentage of desorption of carbon black therefrom, thereby failing to achieve the improvement of the dispersibility in the binder resin upon the production of the black toner. On the other hand, when the amount of the aluminum compound added is more than 50% by weight, the coating effect is saturated and, therefore, it is meaningless to add such an excess amount of the aluminum compound.

As the silicon compounds, there may be exemplified #3 water glass, sodium orthosilicate, sodium metasilicate, colloidal silica or the like.

The amount of the silicon compound added is 0.01 to 50% by weight (calculated as SiO₂) based on the weight of the hematite particles or iron oxide hydroxide particles. When the amount of the silicon compound added is less than 0.01% by weight, it may be difficult to sufficiently coat the surfaces of the hematite particles or iron oxide hydroxide particles with hydroxides and/or oxides of silicon, which can achieve the improvement of lessening the percentage of desorption of carbon black therefrom, thereby failing to achieve the improvement of the dispersibility in the binder resin upon the production of the black toner. On the other hand, when the amount of the silicon compound added is more than 50% by weight, the coating effect is saturated and, therefore, it is meaningless to add such an excess amount of the silicon compound.

In the case where both the aluminum and silicon compounds are used in combination for the coating, the total amount of the aluminum and silicon compounds added is preferably 0.01 to 50% by weight (calculated as a sum of Al and SiO₂) based on the weight of the hematite particles or iron oxide hydroxide particles.

Next, the process for producing the high-resistant black toner according to the present invention is described.

The high-resistant black toner may be produced by mixing and kneading a predetermined amount of a binder resin and a predetermined amount of the black non-magnetic composite particles together, and then pulverizing the mixed and kneaded material into particles. More specifically, the black non-magnetic composite particles and the binder resin are intimately mixed together with, if necessary, a mold release agent, a colorant, a charge-controlling agent or other additives by using a mixer. The obtained mixture is then melted and kneaded by a heating kneader, thereby dispersing the black non-magnetic composite particles in the binder resin. Successively, the molten mixture is cooled and solidified to obtain a resin-kneaded product. The obtained resin-kneaded product is then pulverized and classified, thereby producing a black toner having an aimed particle size.

As the mixers, there may be used a Henschel mixer, a ball mill or the like. As the heating kneaders, there may be used a roll mill, a kneader, a twin-screw extruder or the like. The pulverization of the resin mixture may be conducted by using pulverizers such as a cutter mill, a jet mill or the like. The classification of the pulverized particles may be conducted by known methods such as air classification, etc., as described in Japanese Patent No. 2683142 or the like.

As the other method of producing the black toner, there may be exemplified a suspension polymerization method or an emulsion polymerization method. In the suspension polymerization method, polymerizable monomers and the black non-magnetic composite particles are intimately mixed together with, if necessary, a colorant, a polymerization initiator, a cross-linking agent, a charge-controlling agent or the other additives and then the obtained mixture is dissolved and dispersed together so as to obtain a monomer composition. The obtained monomer composition is added to a water phase containing a suspension stabilizer while stirring, thereby granulating and polymerizing the composition to form black toner particles having an aimed particle size.

In the emulsion polymerization method, the monomers and the black non-magnetic composite particles are dispersed in water together with, if necessary, a colorant, a polymerization initiator or the like and then the obtained dispersion is polymerized while adding an emulsifier thereto, thereby producing black toner particles having an aimed particle size.

A point of the present invention lies in that the black non-magnetic composite particles comprising the hematite particles or iron oxide hydroxide particles as the core particles, which are obtained by firmly adhering carbon black onto the surfaces of the hematite particle or iron oxide hydroxide particle in an amount of 26 to 55 parts by weight based on 100 parts by weight of the hematite particle or iron oxide hydroxide particle, are not only more excellent in fluidity and blackness, but also have a less amount of carbon black desorbed or fallen-off from the surface of each particle.

The reason why the amount of the carbon black desorbed (or fallen-off) from the surfaces of the black non-magnetic composite particles according to the present invention, is small, is considered as follows. That is, the surfaces of the hematite particles or iron oxide hydroxide particles as the core particles and the organosilicon compounds are strongly bonded to each other, so that the carbon black bonded to the surfaces of the hematite particles or iron oxide hydroxide particles through the organosilicon compounds can be prevented from being desorbed from the hematite particles or iron oxide hydroxide particles.

In particular, in the case of the alkoxysilane compounds, metalloxane bonds (≡Si—O—M wherein M represents a metal atom contained in the hematite particles or iron oxide hydroxide particles as the core particles, such as Si, Al, Fe or the like) are formed between the surfaces of the hematite particles or iron oxide hydroxide particles and alkoxy groups contained in the organosilicon compounds onto which the single carbon black coat is formed, thereby forming a stronger bond between the organosilicon compounds on which the single carbon black coat is formed, and the surfaces of the hematite particles or iron oxide hydroxide particles.

In addition, it is considered that when polysiloxane is used, various functional groups of the polysiloxane on which the carbon black is adhered, are firmly bonded to the surfaces of the hematite particles or iron oxide hydroxide particles.

In accordance with the present invention, due to the less amount of carbon black desorbed or fallen-off from the surfaces of the black non-magnetic composite particles, it is assured to sufficiently disperse the black non-magnetic composite particles in a binder resin without any disturbance by desorbed carbon black. Further, since the carbon black adhered on the surfaces of the core particles form irregularities thereon, the obtained black non-magnetic composite particles are prevented from contacting with each other, resulting in excellent dispersibility in a binder resin upon production of the black toner.

The reason why the black non-magnetic composite particles used in the present invention can show a more excellent fluidity, is considered as follows. That is, the single carbon black coat is allowed to be uniformly and densely formed on the surfaces of the hematite particles or iron oxide hydroxide particles as the core particles, so that many fine irregularities are formed on the surfaces of the hematite particles or iron oxide hydroxide particles.

The reason why the black non-magnetic composite particles used in the present invention can show a more excellent blackness, is considered such that since the single carbon black coat is uniformly and densely formed on the surfaces of the hematite particles or iron oxide hydroxide particles as the core particles, the color tone of the core particles is hidden behind the carbon black, so that an inherent color tone of carbon black can be exhibited.

The black toner of the present invention obtained by using the above black non-magnetic composite particles on which a large amount of carbon black is adhered, not only maintains a resistivity as high as not less than 1×10¹³ Ω·cm, but also exhibits more excellent fluidity and blackness.

The reason why the black toner according to the present invention can show a more excellent fluidity, is considered as follows. That is, the black non-magnetic composite particles on which a large amount of the carbon black are uniformly formed, are blended in the black toner, so that many fine irregularities are formed on the surface of the black toner.

The reason why the black toner according to the present invention can show a more excellent blackness, is considered such that the black non-magnetic composite particles having a more excellent blackness is blended in the black toner.

Further, the reason why the black toner according to the present invention can maintain a high volume resistivity value irrespective of a large amount of carbon black adhered, is considered as follows.

That is, in general, carbon black is present in the form of aggregated particles constituted from parallel-stacked crystallites each having a pseudo-graphite structure. Further, the carbon black particles are chemically and physically bonded with each other to form a cluster-like (grape-like cluster) structure. It is known that the larger the cluster-like structure, the higher the electrical conductivity of carbon black becomes. In the case where the carbon black fine particles having such a cluster-like structure are added to and mixed with a binder resin, those exposed to the surface of the black toner also have the cluster-like structure, thereby increasing a conductivity of the black toner. As a result, it is difficult to obtain a black toner having a high volume resistivity value. On the contrary, in the case of the black non-magnetic composite particles used the present invention, the single carbon black coat is formed onto the surface of each core particle without forming the cluster-like structure. Therefore, since the black toner using such black non-magnetic composite particles are also free from carbon black having the cluster-like structure, thereby enabling to maintain a high volume resistivity value.

As described above, since the black non-magnetic composite particles used in the present invention, are more excellent not only in fluidity and blackness, but also in dispersibility in a binder resin due to less amount of the carbon black desorbed or (fallen-off) from the surfaces thereof, the black non-magnetic composite particles used in the present invention, are suitable as black non-magnetic composite particles for black toner capable of attaining a high image quality and a high copying speed.

In addition, since the black non-magnetic composite particles used in the present invention, are excellent in dispersibility in a binder resin, the particles can show excellent handling property and workability and, therefore, are preferable from an industrial viewpoint.

Further, the black toner produced from the above black non-magnetic composite particles which are more excellent in fluidity and blackness, can also show more excellent fluidity and blackness. Accordingly, the black toner is suitable as black toner capable of attaining a high image quality and a high copying speed.

The black toner according to the present invention can maintain a high resistivity value irrespective of using such black non-magnetic composite particles containing a large amount of carbon black adhered thereonto. Therefore, the black toner of the present invention is suitable as a high resistant or insulating toner.

### EXAMPLES

The present invention is described in more detail by Examples and Comparative Examples, but the Examples are only illustrative and, therefore, not intended to limit the scope of the present invention.

Various properties were measured by the following methods.

(1) The average particle size, the average major axial diameter and average minor axial diameter of hematite particles or iron oxide hydroxide particles, composite particles, black non-magnetic composite particles and carbon black fine particles were respectively expressed by the average of values (measured in a predetermined direction) of about 350 particles which were sampled from a micrograph obtained by magnifying an original electron micrograph (×20,000) by four times in each of the longitudinal and transverse directions.

(2) The aspect ratio of the particles was expressed by the ratio of average major axial diameter to average minor axial diameter thereof. The sphericity of the particles was expressed by the ratio of an average particle length to an average particle breadth thereof.

(3) The geometrical standard deviation of particle size was expressed by values obtained by the following method. That is, the particle diameters (or major axial diameters) were measured from the above magnified electron micrograph. The actual particle diameters (or major axial diameters) and the number of the particles were calculated from the measured values. On a logarithmic normal probability paper, the particle diameters (or major axial diameters) were plotted at regular intervals on the abscissa-axis and the accumulative number (under integration sieve) of particles belonging to each interval of the particle diameters (or major axial diameters) were plotted by percentage on the ordinate-axis by a statistical technique.

The particle sizes (or major axial diameters) corresponding to the number of particles of 50% and 84.13%, respectively, were read from the graph, and the geometrical standard deviation was calculated from the following formula:

Geometrical standard deviation={particle sizes (or major axial diameters) corresponding to 84.13% under integration sieve}/{particle sizes (or major axial diameters) (geometrical average diameter) corresponding to 50% under integration sieve}

The closer to 1 the geometrical standard deviation value, the more excellent the particle diameter distribution.

(4) The specific surface area was expressed by the value measured by a BET method.

(5) The amount of Mn which was present within hematite particles or iron oxide hydroxide particles or on surfaces thereof, the amounts of Al and Si which were present within black non-magnetic composite particles or on surfaces thereof, and the amount of Si contained in the organosilicon compounds and the amount of Si contained in dimethylpolysiloxanes used for adhering the carbon black, were measured by a fluorescent X-ray spectroscopy device 3063 M (manufactured by Rigaku Denki Kogyo Co., Ltd.) according to JIS K0119 “General rule of fluorescent X-ray analysis”.

(6) The amount of carbon black coat formed on the surface of the hematite particles or iron oxide hydroxide particles was measured by “Horiba Metal, Carbon and Sulfur Analyzer EMIA-2200 Model” (manufactured by Horiba Seisakusho Co., Ltd.).

(7) The thickness of carbon black coat formed onto the hematite particles or iron oxide hydroxide particles is expressed by the value which was obtained by first measuring an average thickness of carbon black coat formed onto the surfaces of the particles on a photograph (×5,000,000) obtained by magnifying (ten times) a micrograph (×500,000) produced at an accelerating voltage of 200 kV using a transmission-type electron microscope (JEM-2010, manufactured by Japan Electron Co., Ltd.), and then calculating an actual thickness of carbon black coat formed from the measured average thickness.

(8) The fluidity of hematite particles or iron oxide hydroxide particles, composite particles, black non-magnetic composite particles and black toner was expressed by a fluidity index which was a sum of indices obtained by converting on the basis of the same reference measured values of an angle of repose, a degree of compaction (%), an angle of spatula and a degree of agglomeration as particle characteristics which were measured by a powder tester (tradename, produced by Hosokawa Micron Co., Ltd.). The closer to 100 the fluidity index, the more excellent the fluidity of the particles.

(9) The blackness of hematite particles or iron oxide hydroxide particles, composite particles, black non-magnetic composite particles and black toner was measured by the following method. That is, 0.5 g of sample particles and 1.5 ml of castor oil were intimately kneaded together by a Hoover's muller to form a paste. 4.5 g of clear lacquer was added to the obtained paste and was intimately kneaded to form a paint. The obtained paint was applied on a cast-coated paper by using a 6-mil (150 μm) applicator to produce a coating film piece (having a film thickness of about 30 μm). The thus obtained coating film piece was measured according to JIS Z 8729 by a multi-light source spectrographic calorimeter MSC-IS-2D (manufactured by Suga Testing Machines Manufacturing Co., Ltd.) to determine an L* value of calorimetric indices thereof. The blackness was expressed by the L* value measured.

Here, the L* value represents a lightness, and the smaller the L* value, the more excellent the blackness.

(10) The desorption percentage of carbon black desorbed from the composite particles and black non-magnetic composite particles was measured by the following method. The closer to zero the desorption percentage, the smaller the amount of carbon black desorbed from the surfaces of the composite particles and black non-magnetic composite particles.

That is, 3 g of the sample particles and 40 ml of ethanol were placed in a 50-ml precipitation pipe and then were subjected to ultrasonic dispersion for 20 minutes. Thereafter, the obtained dispersion was allowed to stand for 120 minutes, and the carbon black desorbed was separated from the sample particles on the basis of the difference in specific gravity between both the particles. Next, the sample particles from which the desorbed carbon black were separated, were mixed again with 40 ml of ethanol, and the obtained mixture was further subjected to ultrasonic dispersion for 20 minutes. Thereafter, the obtained dispersion was allowed to stand for 120 minutes, thereby separating the sample particles and the carbon black desorbed from each other. The thus obtained particles were dried at 100° C. for one hour, and then the carbon content thereof was measured by the “Horiba Metal, Carbon and Sulfur Analyzer EMIA-2200 Model” (manufactured by Horiba Seisakusho Co., Ltd.). The desorption percentage of the carbon black was calculated according to the following formula:

Desorption percentage of carbon black (%)={(Wa−We)/Wa}×100

wherein Wa represents an amount of carbon black initially formed on the composite particles or the black non-magnetic composite particles; and We represents an amount of carbon black fine particles still adhered on the composite particles or the black non-magnetic composite particles after desorption test.

(11) The dispersibility in a binder resin of the black non-magnetic composite particles was evaluated by counting the number of undispersed agglomerated particles on a micrograph (×200) obtained by photographing a sectional area of the obtained black toner particle using an optical microscope (BH-2, manufactured by Olympus Kogaku Kogyo Co., Ltd.), and classifying the results into the following five ranks. The 5th rank represents the most excellent dispersing condition.

Rank 1: not less than 50 undispersed agglomerated particles per 0.25 mm² were recognized;

Rank 2: 10 to 49 undispersed agglomerated particles per 0.25 mm² were recognized;

Rank 3: 5 to 9 undispersed agglomerated particles per 0.25 mm² were recognized;

Rank 4: 1 to 4 undispersed agglomerated particles per 0.25 mm² were recognized;

Rank 5: No undispersed agglomerated particles were recognized.

(12) The volume resistivity of the black toner was measured by the following method.

That is, first, 0.5 g of a sample particles to be measured was weighted, and press-molded at 1.372×10⁷ Pa (140 Kg/cm²) using a KBr tablet machine (manufactured by Simazu Seisakusho Co., Ltd.), thereby forming a cylindrical test piece.

Next, the thus obtained cylindrical test piece was exposed to an atmosphere maintained at a temperature of 25° C. and a relative humidity of 60% for 12 hours. Thereafter, the cylindrical test piece was set between stainless steel electrodes, and a voltage of 15V was applied between the electrodes using a Wheatstone bridge (TYPE2768, manufactured by Yokogawa-Hokushin Denki Co., Ltd.) to measure a resistance value R (Ω).

The cylindrical test piece was measured with respect to an upper surface area A (cm²) and a thickness t₀ (cm) thereof. The measured values were inserted into the following formula, thereby obtaining a volume resistivity (Ω·cm).

Volume resistivity (Ω·cm)=R×(A/t₀)

(13) The average particle size of the black toner was measured by a laser diffraction-type particle diameter distribution-measuring apparatus (Model HELOSLA/KA, manufactured by Sympatec Corp.).

### Example 1

<Production of Black Non-magnetic Composite Particles>

20 kg of granular-shaped Mn-containing hematite particles (average particle size: 0.32 μm; sphericity: 1.3; geometrical standard deviation value: 1.49; BET specific surface area value: 3.1 m²/g; Mn content: 13.1% by weight (calculated as Mn) based on the weight of the particle; fluidity index: 31; blackness (L* value): 22.4), were deagglomerated in 150 liters of pure water using a stirrer, and further passed through a “TK pipeline homomixer” (tradename, manufactured by Tokushu Kika Kogyo Co., Ltd.) three times, thereby obtaining a slurry containing the granular-shaped Mn-containing hematite particles.

Successively, the obtained slurry containing the granular-shaped Mn-containing hematite particles was passed through a transverse-type sand grinder (tradename “MIGHTY MILL MHG-1.5L”, manufactured by Inoue Seisakusho Co., Ltd.) five times at an axis-rotating speed of 2,000 rpm, thereby obtaining a slurry in which the granular-shaped Mn-containing hematite particles were dispersed.

The particles in the obtained slurry which remained on a sieve of 325 meshes (mesh size: 44 μm) was 0%. The slurry was filtered and washed with water, thereby obtaining a filter cake containing the granular-shaped Mn-containing hematite particles. After the obtained filter cake containing the granular-shaped Mn-containing hematite particles was dried at 120° C., 11.0 kg of the dried particles were then charged into an edge runner “MPUV-2 Model” (tradename, manufactured by Matsumoto Chuzo Tekkosho Co., Ltd.), and mixed and stirred at 294 N/cm (30 Kg/cm) and a stirring speed of 22 rpm for 30 minutes, thereby lightly deagglomerating the particles.

220 g of methyltriethoxysilane (tradename: “TSL8123”, produced by GE Toshiba Silicone Co., Ltd.) was mixed and diluted with 200 ml of ethanol to obtain a methyl triethoxysilane solution. The methyl triethoxysilane solution was added to the deagglomerated granular-shaped Mn-containing hematite particles under the operation of the edge runner. The granular-shaped Mn-containing hematite particles were continuously mixed and stirred at a linear load of 588 N/cm (60 Kg/cm) and a stirring speed of 22 rpm for 30 minutes.

Next, 3300 g of carbon black fine particles B (particle shape: granular shape; average particle size: 0.022 μm; geometrical standard deviation value: 1.78; BET specific surface area value: 133.5 m²/g; DBP oil absorption: 84 ml/100 g; and blackness (L* value): 14.6) were added to the granular-shaped Mn-containing hematite particles coated with methyltriethoxysilane for 180 minutes while operating the edge runner. Further, the mixed particles were continuously stirred at a linear load of 588 N/cm (60 Kg/cm) and a stirring speed of 22 rpm for 60 minutes to form the carbon black coat on the coating layer composed of methyltriethoxysilane, and then the obtained particles were hear-treated at a temperature of 105° C. for 60 minutes by using dryer, thereby obtaining black non-magnetic composite particles.

The obtained black non-magnetic composite particles had an average particle size of 0.33 μm, and a sphericity of 1.3:1 as shown in the electron photograph. In addition, the black non-magnetic composite particles showed a geometrical standard deviation of 1.49, a BET specific surface area value of 7.9 m²/g, fluidity index of 53, a blackness (L* value) of 16.1, and a desorption percentage of carbon black: 9.2%. The amount of the carbon black coat formed on the coating layer composed of the organosilane compound produced from methyltriethoxysilane is 23.13% by weight (calculated as C) based on the weight of the black non-magnetic composite particles (corresponding to 30 parts by weight based on 100 parts by weight of the granular-shaped Mn-containing hematite particles). The thickness of the carbon black coat formed was 0.0027 μm. The amount of dimethylpolysiloxanes adhered was 0.30% by weight (calculated as Si). Since no carbon black were recognized on the electron photograph, it was confirmed that a whole amount of the carbon black used contributed to the formation of the carbon black coat.

### Example 2

<Production of Black Toner Containing Black Non-magnetic Composite Particles>

400 g of the black non-magnetic composite particles obtained in the Example 1, 600 g of styrene-butyl acrylate-methyl methacrylate copolymer resin (molecular weight=130,000, styrene/butyl acrylate/methyl methacrylate=82.0/16.5/1.5), 60 g of polypropylene wax (molecular weight: 3,000) and 15 g of a charge-controlling agent were charged into a Henschel mixer, and mixed and stirred therein at 60° C. for 15 minutes. The obtained mixed particles were melt-kneaded at 140° C. using a continuous-type twin-screw kneader (T-1), and the obtained kneaded material was cooled, coarsely pulverized and finely pulverized in air. The obtained particles were subjected to classification, thereby producing a black toner.

The obtained black toner had an average particle size of 10.1 μm, a dispersibility of 5th rank, a fluidity index of 86, a blackness (L* value) of 17.6, a volume resistivity of 3.4×10¹³ Ω·cm.

Core Particles 2

The same procedure as defined in Example 1 was conducted by using 20 kg of the deagglomerated granular-shaped Mn-containing hematite particles (core particles 1) and 150 liters of water, thereby obtaining a slurry containing the granular-shaped Mn-containing hematite particles. The pH value of the obtained re-dispersed slurry containing the granular-shaped Mn-containing hematite particles was adjusted to 10.5 by adding an aqueous sodium solution, and then the concentration of the slurry was adjusted to 98 g/liter by adding water thereto. After 150 liters of the slurry was heated to 60° C., 5444 ml of a 1.0 mol/liter sodium alminate solution (equivalent to 1.0% by weight (calculated as Al) based on the weight of the granular-shaped Mn-containing hematite particles) was added to the slurry. After allowing the slurry to stand for 30 minutes, the pH value of the slurry was adjusted to 7.5 by adding an acetic acid solution. After allowing the slurry to stand for 30 minutes, the slurry was subjected to filtration, washing with water, drying and pulverization, thereby obtaining the granular-shaped Mn-containing hematite particles coated with hydroxides of aluminum.

Main production conditions are shown in Table 2, and various properties of the obtained granular-shaped Mn-containing hematite particles coated with hydroxides of aluminum are shown in Table 3.

### Example 3

<Production of Composite Particles>

The same procedure as defined in Example 1 was conducted except that kind of hematite particles to be treated, kind and amount of the polysiloxane added, treating conditions of edge runner in the coating treatment, kind and amount of the carbon black coat formed, method of adding the carbon black fine particles, and treating conditions of edge runner used in the forming process of the carbon black coat, were varied, thereby obtaining composite particles. Meanwhile, carbon black fine particles were added in four lots in which the amount of each lot thereof was 10.0 parts by weight based on 100 parts by weight of the core particles. The composite particles obtained in Example 2 were observed by an electron microscope. As a result, almost no independent carbon black was recognized. Therefore, it was confirmed that a substantially whole amount of the carbon black contributed to the formation of the carbon black coat on the coating layer composed of methyl hydrogen polysiloxane.

Various properties of the carbon black fine particles B to C are shown in Table 4.

Main production conditions are shown in Table 5, and various properties of the obtained black non-magnetic composite particles are shown in Table 6.

Meanwhile, in Example 3, “TSF484” (tradename, produced by GE Toshiba Silicone Co., Ltd.) was methyl hydrogen polysiloxane.

### Example 4

<Production of Black Toner>

The same procedure as defined in Example 2 was conducted by using the black non-magnetic composite particles obtained in Example 3 and kind and amount of the binder resin, thereby obtaining black toners.

Main production conditions and various properties of the obtained black toners are shown in Table 7.

TABLE 1

| | |
|---|---|
| Core | Properties of core particles |

| particles | Kind | Particle shape |
|---|---|---|
| Core | Mn-containing hematite | Granular |
| particles 1 | particles | |

| | Properties of core particles | | | |
|---|---|---|---|---|
| | | | Geometrical | BET |
| | Average | | standard | specific |
| | particle | | deviation | surface |
| Core | size | Sphericity | value | area |
| particles | (μm) | (−) | (−) | (m²/g) |
| Core | 0.32 | 1.3:1 | 1.49 | 3.1 |
| particles 1 | | | | |

| | Properties of core particles | | |
|---|---|---|---|
| | | Fluidity | Blackness |
| Core | Mn content | index | (L* value) |
| particles | (wt. %) | (−) | (−) |
| Core | 13.1 | 31 | 22.4 |
| particles 1 | | | |

TABLE 2

| | | Surface-treatment step | | |
|---|---|---|---|---|
| | Kind of | Additives | | |
| Core | core | | Calculated | Amount |
| particles | particles | Kind | as | (wt. %) |
| Core | Core | Sodium | Al | 1.0 |
| particles 2 | particles 1 | aluminate | | |

| | Surface-treatment step | | |
|---|---|---|---|
| | Coating material | | |
| Core | | | Amount |
| particles | Kind | Calculated as | (wt. %) |
| Core | A | Al | 0.98 |
| particles 2 | | | |

Note;
A: Hydroxide of aluminum

TABLE 3

| | Properties of surface-treated core particles | | |
|---|---|---|---|
| | | | Geometrical |
| | Average | | standard |
| Core | particle size | Sphericity | deviation value |
| particles | (μm) | (−) | (−) |
| Core | 0.32 | 1.3:1 | 1.47 |
| particles 2 | | | |

| | Properties of surface-treated core | | |
|---|---|---|---|
| | particles | | |
| | | Fluidity | Blackness |
| Core | Mn content | index | (L* value) |
| particles | (wt. %) | (−) | (−) |
| Core | 12.9 | 30 | 22.7 |
| particles 2 | | | |

TABLE 4

| | Properties of carbon black fine particles | | |
|---|---|---|---|
| | | | Geometrical |
| Kind of | | | standard |
| carbon | | Average | deviation |
| black fine | | particle size | value |
| particles | Particle shape | (μm) | (−) |
| Carbon | Granular | 0.022 | 1.78 |
| black B | | | |
| Carbon | Granular | 0.015 | 1.56 |
| black C | | | |

| | Properties of carbon black fine particles | | |
|---|---|---|---|
| Kind of | | | |
| carbon | BET specific | DBP oil | Blackness |
| black fine | surface area | absorption | (L* value) |
| particles | (m²/g) | (ml/100 g) | (−) |
| Carbon | 133.5 | 84 | 14.6 |
| black B | | | |
| Carbon | 265.3 | 57 | 15.2 |
| black C | | | |

TABLE 5

Production of black non-
magnetic composite
particles Coating
with alkoxysilane or
polysiloxane
Additives

| | | | Amount |
|---|---|---|---|
| | | | added |
| | Kind of core | | (part by |
| Examples | particles | Kind | weight) |
| Example 1 | Core | Methyl | 2.0 |
| | particles 1 | triethoxysilane | |
| Example 3 | Core | TSF484 | 2.0 |
| | particles 2 | | |

Production of black non-magnetic composite
particles
Coating with alkoxysilane or polysiloxane

| | | Coating amount |
|---|---|---|
| Edge runner treatment | | (calculated as |
| Linear load | Time | Si) |

| Examples | (N/cm) | (Kg/cm) | (min.) | (wt. %) |
|---|---|---|---|---|
| Example 1 | 588 | 60 | 30 | 0.30 |
| Example 3 | 588 | 60 | 30 | 0.81 |

Production of black non-magnetic
composite particles
Adhesion step with carbon
black coat
Carbon black

| | | Amount adhered |
|---|---|---|
| Examples | Kind | (parts by weight) |
| Example 1 | B | 30.0 |
| Example 3 | C | 50.0 |

Production of black non-magnetic composite
particles
Adhesion step with carbon black coat

| | | Amount adhered |
|---|---|---|
| Edge runner treatment | | (calculated as |
| Linear load | Time | C) |

| Examples | (N/cm) | (Kg/cm) | (min.) | (wt. %) |
|---|---|---|---|---|
| Example 1 | 588 | 60 | 60 | 23.13 |
| Example 3 | 588 | 60 | 90 | 33.15 |

TABLE 6

| | Properties of black non-magnetic composite | | |
|---|---|---|---|
| | particles | | |
| | Average | | Geometrical |
| | particle | | standard |
| | size | Sphericity | deviation value |
| Examples | (μm) | (−) | (−) |
| Example 1 | 0.33 | 1.3 | 1.49 |
| Example 3 | 0.34 | 1.3 | 1.50 |

Properties of black non-magnetic composite
particles

| | BET specific surface | Mn content |
|---|---|---|
| Examples | area (m²/g) | (wt. %) |
| Example 1 | 7.9 | 9.7 |
| Example 3 | 18.6 | 9.3 |

Properties of black non-magnetic composite
particles

| | | | Carbon | |
|---|---|---|---|---|
| | | | black | Carbon |
| | Fluidity | Blackness | desorption | black coat |
| | index | (L* value) | percentage | thickness |
| Examples | (−) | (−) | (%) | (μm) |
| Example 1 | 53 | 16.1 | 9.2 | 0.0027 |
| Example 3 | 54 | 16.0 | 9.8 | 0.0029 |

TABLE 7

Production of black toner
Black non-magnetic composite particles

| | | Amount blended |
|---|---|---|
| Examples | Kind | (part by weight) |
| Example 2 | Example 1 | 40 |
| Example 4 | Example 3 | 40 |

Production of black toner
Binder resin

| | | Amount blended |
|---|---|---|
| Examples | Kind | (part by weight) |
| Example 2 | Styrene-acrylic | 60 |
| | copolymer resin | |
| Example 4 | Styrene-acrylic | 60 |
| | copolymer resin | |

| | Properties of black toner | | |
|---|---|---|---|
| | Average | | |
| | particle size | Dispersibility | Fluidity index |
| Examples | (μm) | (−) | (−) |
| Example 2 | 10.1 | 5 | 86 |
| Example 4 | 9.8 | 5 | 86 |

Properties of black toner

| | | Blackness |
|---|---|---|
| | Volume resistivity | (L* value) |
| Examples | value (Ω · cm) | (−) |
| Example 2 | 3.4 × 10¹³ | 17.6 |
| Example 4 | 2.2 × 10¹³ | 17.5 |

What is claimed is:

1. A black toner comprising:
a binder resin; and
black non-magnetic composite particles having an average particle diameter of 0.06 to 1.0 μm, comprising:
hematite particles or iron oxide hydroxide particles as core particles;
a coating layer formed on the surface of said hematite particles or iron oxide hydroxide particles, comprising at least one organosilicon compound selected from the group consisting of:
(1) organosilane compounds obtained from an alkoxysilane compounds, and
(2) polysiloxanes or modified polysiloxanes; and
a single carbon black coat formed on said coating layer comprising said organosilicon compound, in an amount of 26 to 55 parts by weight based on 100 parts by weight of said hematite particles or iron oxide hydroxide particles.

2. A black toner according to claim 1, wherein the amount of the binder resin is 50 to 3500 parts by weight based on 100 parts by weight of the black non-magnetic composite particles.

3. A black toner according to claim 1, which further comprises an average particle diameter of 3 to 25 μm.

4. A black toner according to claim 1, which further comprises a fluidity index of 78 to 100.

5. A black toner according to claim 1, which further comprises a blackness (L* value) of 15 to 19.

6. A black toner according to claim 1, which further comprises a volume resistivity of not less than 1.0×10¹³ Ω·cm.

7. A black toner according to claim 1, wherein a coat comprising at least one compound selected from the group consisting of hydroxides of aluminum, oxides of aluminum, hydroxides of silicon and oxides of silicon, is disposed between at least a part of the surface of said hematite particles or iron oxide hydroxide particles and the coating layer comprising at least one organosilicon compound in an amount of 0.01 to 50% by weight, calculated as Al or SiO₂, based on the total weight of the hematite particles or iron oxide hydroxide particles.

8. A black toner according to claim 1, wherein said modified polysiloxanes are compounds selected from the group consisting of:
(A) polysiloxanes modified with at least one compound selected from the group consisting of polyethers, polyesters and epoxy compounds, and
(B) polysiloxanes whose molecular terminal is modified with at least one group selected from the group consisting of carboxylic acid groups, alcohol groups and a hydroxyl group.

9. A black toner according to claim 1, wherein said alkoxysilane compound is represented by the general formula (I):
R¹ₐSiX₄₋ₐ (I)
wherein R¹ is C₆H₅—, (CH₃)₂CHCH₂— or n-C_{b}H_{2b+1}— (wherein b is an integer of 1 to 18); X is CH₃O— or C₂H₅O—; and a is an integer of 0 to 3.

10. A black toner according to claim 9, wherein said alkoxysilane compound is methyltriethoxysilane, dimethyldiethoxysilane, phenyltriethoxysilane, diphenyldiethoxysilane, methyltrimethoxysilane, dimethyldimethoxysilane, phenyltrimethoxysilane, diphenyldimethoxysilane, isobutyltrimethoxysilane or decyltrimethoxysilane.

11. A black toner according to claim 1, wherein said polysiloxanes are represented by the general formula (II): 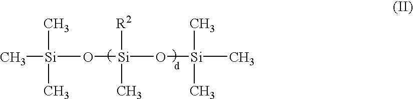
wherein R² is H— or CH₃—, and d is an integer of 15 to 450.

12. A black toner according to claim 11, wherein said polysiloxanes are compounds having methyl hydrogen siloxane units.

13. A black toner according to claim 8, wherein said polysiloxanes modified with at least one compound selected from the group consisting of polyethers, polyesters and epoxy compounds are represented by the general formula (III), (IV) or (V): 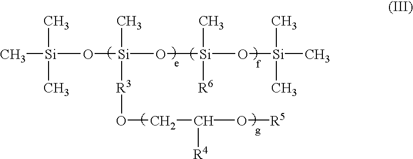
wherein R³ is —(—CH₂—)ₕ—; R⁴ is —(—CH₂—)ᵢ—CH₃; R⁵ is —OH, —COOH, —CH═CH₂, —C(CH₃)═CH₂ or —(—CH₂—)ⱼ—CH₃; R⁶ is —(—CH₂—)ₖ—CH₃; g and h are an integer of 1 to 15; i, j and k are an integer of 0 to 15; e is an integer of 1 to 50; and f is an integer of 1 to 300; 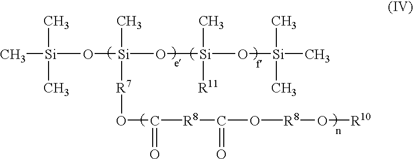
wherein R⁷, R⁸ and R⁹ are —(—CH₂—)_{q}— and may be the same or different; R¹⁰ is —OH, —COOH, —CH═CH₂, —C(CH₃)═CH₂ or —(—CH₂—)ᵣ—CH₃; R¹¹ is —(—CH₂—)ₛ—CH₃; n and q are an integer of 1 to 15; r and s are an integer of 0 to 15; e′ is an integer of 1 to 50; and f′ is an integer of 1 to 300; or 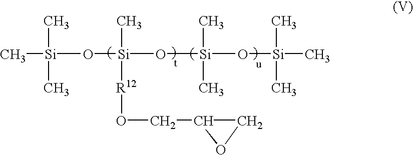
wherein R¹² is —(—CH₂—)ᵥ—; v is an integer of 1 to 15; t is an integer of 1 to 50; and u is an integer of 1 to 300.

14. A black toner according to claim 8, wherein said polysiloxanes whose molecular terminal is modified with at least one group selected from the group consisting of carboxylic acid groups, alcohol groups and a hydroxyl group are represented by the general formula (VI): 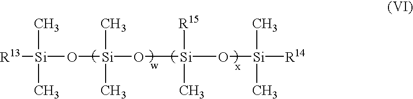
wherein R¹³ and R¹⁴ are —OH, R¹⁶OH or R¹⁷COOH and may be the same or different; R¹⁵ is —CH₃ or —C₆H₅; R¹⁶ and R¹⁷ are —(—CH₂—)_{y}—; y is an integer of 1 to 15; w is an integer of 1 to 200; and x is an integer of 0 to 100.

15. A black toner according to claim 1, wherein the amount of said coating organosilicon compounds is 0.02 to 5.0% by weight, calculated as Si, based on the total weight of the organosilicon compounds and said hematite particles or iron oxide hydroxide particles.

16. A black toner according to claim 1, wherein the thickness of said carbon black coat is not more than 0.06 μm.

17. A black toner according to claim 1, wherein said black non-magnetic composite particles have a geometrical standard deviation of particle diameters of 1.01 to 2.0.

18. A black toner according to claim 1, wherein said black non-magnetic composite particles have a BET specific surface area value of 1 to 200 m²/g, a fluidity index of 48 to 90 and a blackness (L* value) of 15 to 19.5.

19. A method of using black non-magnetic composite particles for production of a black toner, comprising mixing said black non-magnetic composite particles having an average particle diameter of 0.06 to 1.0 μm, with a binder resin,
which black non-magnetic composite particles comprise:
hematite particles or iron oxide hydroxide particles as core particles;
a coating layer formed on the surface of said hematite particles or iron oxide hydroxide particles, comprising at least one organosilicon compound selected from the group consisting of:
(1) organosilane compounds obtained from an alkoxysilane compounds, and
(2) polysiloxanes or modified polysiloxanes; and
a single carbon black coat formed on said coating layer comprising said organosilicon compound, in an amount of 26 to 55 parts by weight based on 100 parts by weight of said hematite particles or iron oxide hydroxide particles.

20. Black non-magnetic composite particles for a black toner,
which have an average particle diameter of 0.06 to 1.0 μm and a sphericity of from 1.0:1 to less than 2.0:1, and comprise:
hematite particles or iron oxide hydroxide particles as core particles;
a coating layer formed on the surface of said hematite particles or iron oxide hydroxide particles, comprising at least one organosilicon compound selected from the group consisting of:
(1) organosilane compounds obtained from an alkoxysilane compounds, and
(2) polysiloxanes or modified polysiloxanes; and
a single carbon black coat formed on said coating layer comprising said organosilicon compound, in an amount of 26 to 55 parts by weight based on 100 parts by weight of said hematite particles or iron oxide hydroxide particles.

21. Black non-magnetic composite particles according to claim 20, wherein a coat comprising at least one compound selected from the group consisting of hydroxides of aluminum, oxides of aluminum, hydroxides of silicon and oxides of silicon, is disposed between at least a part of the surface of said hematite particles or iron oxide hydroxide particles and the coating layer comprising at least one organosilicon compound in an amount of 0.01 to 50% by weight, calculated as Al or SiO₂, based on the total weight of the hematite particles or iron oxide hydroxide particles.

22. Black non-magnetic composite particles according to claim 20, which further have a geometrical standard deviation of particle diameters of 1.01 to 2.0, a BET specific surface area value of 1 to 200 m²/g, a fluidity index of 48 to 90, and a blackness (L* value) of 15 to 19.5.

23. Black non-magnetic composite particles according to claim 20, wherein said modified polysiloxanes are compounds selected from the group consisting of:
(A) polysiloxanes modified with at least one compound selected from the group consisting of polyethers, polyesters and epoxy compounds, and
(B) polysiloxanes whose molecular terminal is modified with at least one group selected from the group consisting of carboxylic acid groups, alcohol groups and a hydroxyl group.

24. Black non-magnetic composite particles according to claim 20, wherein said alkoxysilane compound is represented by the general formula (I):
R¹ₐSiX₄₋ₐ (I)
wherein R¹ is C₆H₅—, (CH₃)₂CHCH₂— or n-C_{b}H_{2b+1}— (wherein b is an integer of 1 to 18); X is CH₃O— or C₂H₅O—; and a is an integer of 0 to 3.

25. Black non-magnetic composite particles according to claim 24, wherein said alkoxysilane compound is methyltriethoxysilane, dimethyldiethoxysilane, phenyltriethoxysilane, diphenyldiethoxysilane, methyltrimethoxysilane, dimethyldimethoxysilane, phenyltrimethoxysilane, diphenyldimethoxysilane, isobutyltrimethoxysilane or decyltrimethoxysilane.

26. Black non-magnetic composite particles according to claim 20, wherein said polysiloxanes are represented by the general formula (II): 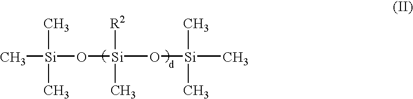
wherein R² is H— or CH₃—, and d is an integer of 15 to 450.

27. Black non-magnetic composite particles according to claim 26, wherein said polysiloxanes are compounds having methyl hydrogen siloxane units.

28. Black non-magnetic composite particles according to claim 23, wherein said polysiloxanes modified with at least one compound selected from the group consisting of polyethers, polyesters and epoxy compounds are represented by the general formula (III), (IV) or (V): 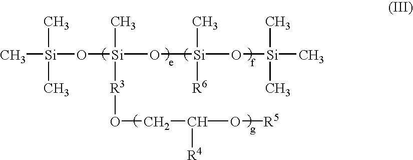
wherein R³ is —(—CH₂—)ₕ—; R⁴ is —(—CH₂—)ᵢ—CH₃; R⁵ is —OH, —COOH, —CH═CH₂, —C(CH₃)═CH₂ or —(—CH₂—)ⱼ—CH₃; R⁶ is —(—CH₂—)ₖ—CH₃; g and h are an integer of 1 to 15; i, j and k are an integer of 0 to 15; e is an integer of 1 to 50; and f is an integer of 1 to 300; 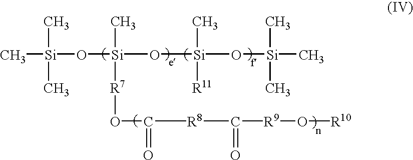
wherein R⁷, R⁸ and R⁹ are —(—CH₂—)_{q}— and may be the same or different; R¹⁰ is —OH, —COOH, —CH═CH₂, —C(CH₃)═CH₂ or —(—CH₂—)ᵣ—CH₃; R¹¹ is —(—CH₂—)ₛ—CH₃; n and q are an integer of 1 to 15; r and s are an integer of 0 to 15; e′ is an integer of 1 to 50; and f′ is an integer of 1 to 300; or 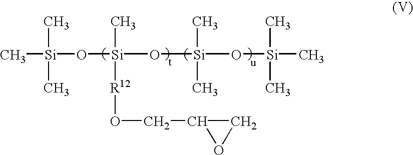
wherein R¹² is —(—CH₂—)ᵥ—; v is an integer of 1 to 15; t is an integer of 1 to 50; and u is an integer of 1 to 300.

29. Black non—magnetic composite particles according to claim 23, wherein said polysiloxanes whose molecular terminal is modified with at least one group selected from the group consisting of carboxylic acid groups, alcohol groups and a hydroxyl group are represented by the general formula (VI): 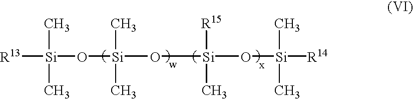
wherein R¹³ and R¹⁴ are —OH, R¹⁶OH or R¹⁷COOH and may be the same or different; R¹⁵ is —CH₃ or —C₆H₅; R¹⁶ and R¹⁷ are —(—CH₂—)_{y}—; y is an integer of 1 to 15; w is an integer of 1 to 200; and x is an integer of 0 to 100.

30. Black non-magnetic composite particles according to claim 20, wherein the amount of said coating organosilicon compounds is 0.02 to 5.0% by weight, calculated as Si, based on the total weight of the organosilicon compounds and said hematite particles or iron oxide hydroxide particles.

31. Black non-magnetic composite particles according to claim 20, wherein the thickness of said carbon black coat is not more than 0.06 μm.
